(19) United States
(12) Patent Application Publication
(10) Pub. No.: US 2010/0196233 A1
(43) Pub. Date: Aug. 5, 2010

(54) APPLICATIONS OF METAL COMPLEX COMPOUNDS

(76) Inventors: Frederick Geoffrey Nethersole Cloke, Brighton Sussex (GB); Owen Timothy Summerscales, York Yorkshire (GB); Darren Frank Lee, Merseyside (GB)

Correspondence Address: POLSINELLI SHUGHART PC, 700 W. 47TH STREET, SUITE 1000, KANSAS CITY, MO, 64112-1802, US

(21) Appl. No.: 12/667,494

(22) PCT Filed: Jul. 10, 2008
(86) PCT No.: PCT/GB2008/050557

§ 371 Date: Dec. 31, 2009

(30) Foreign Application Priority Data
Jul. 10, 2007 (GB) 0713294.7

(51) Int. Cl. C01B 31/20; C01B 21/24; C01B 21/36; C01B 17/50; C01B 3/02; C07F 5/00; C01B 21/22; C01B 17/16

(52) U.S. Cl. 423/226; 423/239.1; 423/242.2; 423/237; 423/248; 534/11

(57) ABSTRACT

The present invention provides a method for binding gaseous molecules, the method comprising contacting gases comprising the gaseous molecules with trivalent metal complexes. Typically, the gaseous molecules comprise polar molecules of greenhouse gases, especially the oxides of carbon, nitrogen and sulphur. Preferably, the trivalent metal complexes comprise complexes of actinide metals, most preferably uranium. The method is particularly useful in the removal of so-called greenhouse gases from the atmosphere, and is therefore of potentially very great value environmentally. The invention also provides trivalent metal complexes comprising sandwich complexes of trivalent metals selected from transition metals and actinide metals, the complexes comprising two ligands selected from pentalenyl, indenyl, cyclopentadienyl and cyclooctatetraene ligands. The invention further provides a method for the preparation of the trivalent metal complexes.

### FIELD OF THE INVENTION

The present invention relates to metal complex compounds and their reactions with small gaseous molecules. More specifically it is concerned with the use of uranium complexes in the treatment of gases such as the oxides of carbon, nitrogen and sulphur.

### BACKGROUND TO THE INVENTION

The problems associated with the generation of so-called “greenhouse gases”, and their rôle in the phenomenon of global warming, are well known and much attention has been devoted to the development of different means by which the volumes of such gases released in emissions may be reduced. Thus, for example, the production of large volumes of greenhouse gases by electricity generation associated with the burning of fossil fuels has resulted in greater interest in alternative means of generation, such as wind, wave and solar power, as well as nuclear power generation. Also, greenhouse gas emission associated with various modes of transport—and most particularly with the rapid growth in use of the internal combustion engine and in the use of air transport—has resulted in significant efforts being made in various quarters to reduce the frequency and distance of journeys.

There seems, however, to be little doubt that, whatever efforts may be made to reduce the volumes of greenhouse gases which are emitted into the atmosphere, their presence will continue to cause problems for many years to come, since it would be impossible to change with sufficient rapidity systems and devices which are already well established commercially. Consequently, attention has also turned to alternative approaches, wherein the greenhouse gases which are emitted are subsequently treated so as to reduce or eliminate the volumes which are released into the atmosphere.

One obvious approach to this problem in certain situations is the use of scrubbers, which are designed to remove the greenhouse gases from the gaseous effluent by reaction or dissolution in a liquid—typically aqueous—scrubbing medium. The disadvantage with this approach, however, is that whilst volumes of gaseous effluents may be significantly reduced in this way, different problems are created as the result of the generation of significant volumes of liquid effluents.

An alternative means of addressing the problem may involve the use of adsorbents, such as activated charcoal, over which the gases are allowed to pass, the specific adsorbent being chosen so as to preferentially adsorb the greenhouse gases which are of particular concern from an environmental perspective in a given situation. However, the large volumes of gases which often have to be treated would typically require the use of significant amounts of adsorbent, with the attendant problems of cost and disposal of adsorbent.

A more successful approach may be by the use of materials which are capable of chemical reaction with—rather than simple physical adsorption of—these greenhouse gases, and this is the approach adopted by the present inventors. Many previous efforts in this field have, however, utilised very aggressive, hazardous and expensive techniques. Thus, for example, the removal of carbon monoxide has typically been achieved via methods such as reductive cyclomerisation using media such as alkali metals in liquid ammonia, or by means of electrolysis procedures. The present inventors have sought to adopt a more convenient and less hazardous approach to the solution of the problem.

There are described in WO-A-99/09034 complexes of trivalent metals, principally thorium and uranium, which find particular use as nitrogen fixation agents, for the production of precursors for ammonia production, and for inserting nitrogen into compounds during synthesis reactions. The disclosed complexes incorporate dinitrogen in their structure and illustrate the capture of a small molecule in a larger metal complex molecule. However, the disclosed complexes are exclusively based on the formation of structures incorporating an inert, symmetrical structure, in the form of nitrogen.

Compounds incorporating uranium which could be used in the preparation of the complexes disclosed in WO-A-9909034 were previously known from WO-98/20971, wherein there were disclosed compounds, and particularly catalysts, which comprised complexes of actinides with at least one ligand, the disclosed compounds being described as finding particular use in the catalysis of polymerisation reactions. This document contained no suggestion of the use of the said compounds in the preparation of complexes by the incorporation of small molecules.

The present inventors have sought to develop an approach by means of which complexes may be formed by the chemical interaction of compounds with small molecules, specifically the small gaseous molecules which comprise greenhouse gases, and thereby allow these gases to be removed from the atmosphere. Surprisingly, it has been found that polar molecules of the greenhouse gases are capable of complex formation with certain complexes of actinide metals, specifically complexes wherein the actinide metal is in the trivalent state.

### SUMMARY OF THE INVENTION

Thus, according to a first aspect of the present invention, there is provided a method for binding gaseous molecules, said method comprising contacting gases comprising said gaseous molecules with trivalent metal complexes.

Said gaseous molecules typically may comprise polar gaseous molecules, most particularly molecules of greenhouse gases, especially the oxides of carbon, nitrogen and sulphur. Most particularly, said gases comprise carbon monoxide, carbon dioxide, nitrogen monoxide, nitrogen dioxide, dinitrogen monoxide and sulphur dioxide, but the use of the method of the invention with polar gaseous molecules such as ammonia, hydrogen sulphide and carbon disulphide is also envisaged, as well as with hydrogen and hydrocarbons such as methane. The procedure of the invention results in the reductive combination of the target gaseous molecules such that, in the case of the oxides of carbon, for example, higher oxygenated hydrocarbons are produced.

The method of the invention may be carried out at ambient temperature and pressure and, as such, offers significant advantages over the methods of the prior art.

Preferably, the trivalent metal complexes which are useful in the context of the method of the present invention comprise complexes of actinide metals, most preferably uranium. Alternatively, said metal complexes may comprise complexes of transition metals, such as titanium, zirconium or hafnium. Particularly preferably, said complexes comprise sandwich complexes. Most preferably, said complexes comprise sandwich complexes of uranium which comprise two aromatic ring systems. Typically, said aromatic ring systems comprise C₅ to C₁₀ aromatic rings including, for example, pentalenyl, indenyl, cyclopentadienyl and cyclooctatetraenyl rings. Especially preferred are the C₅ to C₈ aromatic ring systems.

According to a second aspect of the present invention, there is provided a trivalent metal complex comprising a sandwich complex of a metal, wherein said metal comprises a trivalent metal which is selected from transition metals and actinide metals, said complex comprising two ligands selected from indenyl, cyclopentadienyl and cyclooctatetraenyl ligands.

Optionally, said ligands may be unsubstituted or, alternatively, they may be substituted with from 1 to 5 ring substituents. Typically said ring substituent groups comprise groups selected from alkyl, silyl and alkylsilyl groups, with C₁₋₅ alkyl and alkylsilyl groups being most preferred. Particularly preferred in this respect are methyl groups, butyl groups, preferably tertiary butyl groups, methylsilyl groups and propylsilyl groups, most particularly isopropylsilyl groups. The preferred substituents may comprise mono-, di-, or trialkylsilyl groups, and the most preferred groups are trimethylsilyl and triisopropylsilyl groups.

Preferred examples of the complexes of the second aspect of the invention include 1,4-di(trialkylsilyl)cyclooctatetraene/methylated cyclopentadienyl mixed sandwich uranium(III) complexes (I), 1,4-di(trialkylsilyl)pentalene/methylated cyclopentadienyl mixed sandwich uranium(III) complexes (II), and 1,4-di(trialkylsilyl)cyclooctatetraene/methyl(silyl)ated indenyl mixed sandwich uranium(III) complexes (III).

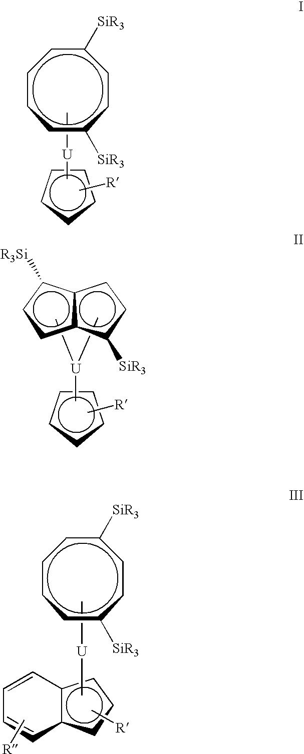

In (I) and (II): R=—CH₃ or —CH(CH₃)₂; R′=—CH₃, —C(CH₃)₃ or Si(CH₃)₃; when R′=—CH₃, n=1-5, and when R′=—C(CH₃)₃ or Si(CH₃)₃, n=1-3.

In (III): R=—CH₃ or —CH(CH₃)₂; R′=—CH₃, —CH(CH₃)₂, —C(CH₃)₃ or Si(CH₃)₃; when R′=—CH₃, p=1-3, and when R′=—CH(CH₃)₂, —C(CH₃)₃ or Si(CH₃)₃, p=1-2; R″=CH₃; r=0-4.

A particularly preferred complex in the context of the first and second aspects of the invention comprises a 1,4-di(triisopropylsily)cyclooctatetraene/methylated cyclopentadienyl mixed sandwich uranium(III) complex, most preferably a 1,4-di(triisopropylsilyl)cyclooctatetraene/pentamethyl-, tetramethyl- or trimethyl-cyclopentadienyl mixed sandwich uranium(III) complex. Said complex may be caused to react with carbon monoxide so as to form a deltate or squarate derivative comprising two molecules of the complex linked by the deltate or squarate ring.

The complexes according to the second aspect of the invention are typically prepared from the metals via the corresponding metal halides. Thus, according to a third aspect of the invention, there is provided a method for the preparation of a trivalent metal complex, said method comprising:
(a) reacting the metal with a halide salt;
(b) reacting the resulting metal halide with a first metal aromatic compound; and
(c) reacting the intermediate so formed with a second metal aromatic compound.

Particularly suitable halide salts for use in the first stage of the synthesis are mercury(II) halides, most particularly mercury(II) iodide. The reactions are typically carried out at elevated temperatures over a prolonged period of time in a sealed tube.

The metal aromatic compounds used in the formation of the complex are preferably alkali metal aromatic compounds, most particularly potassium aromatic compounds such as pentamethyl-, tetramethyl- or trimethyl-cyclopentadienyl potassium and 1,4-di(triisopropylsilyl) cyclooctatetraenyl dipotassium. Reaction of these compounds with the metal halide are typically carried out in organic solvents such as tetrahydrofuran at room temperature and pressure.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

### DETAILED DESCRIPTION OF THE INVENTION

A particularly preferred embodiment of the compounds according to the second aspect of the invention comprises a 1,4-di(triisopropylsilyl)cyclooctatetraene/pentamethyl-, tetramethyl- or trimethyl-cyclopentadienyl mixed sandwich uranium(III) complex. These complexes may be prepared from uranium turnings by firstly reacting the uranium with mercury(II) iodide at 320° C. for 2 days in a sealed tube. The resulting uranium(III) iodide is then reacted firstly with pentamethyl-, tetramethyl- or trimethyl-cyclopentadienyl potassium and then with 1,4-di(triisopropylsilyl)cyclooctatetraenyl dipotassium, both reactions being carried out at room temperature and pressure in tetrahydrofuran.

Further preferred embodiments of the second aspect of the invention include 1,4-di(triisopropylsilyl)cyclooctatetraene/cyclopentadienyl mixed sandwich uranium(III) complexes wherein the cyclopentadiene ring is substituted with alkyl groups other than methyl groups. Preferred alkyl groups include butyl groups, most preferably t-butyl groups. In other preferred embodiments, the substituents comprise mono-, di-, or trialkylsilyl groups, and the most preferred groups in this context are trimethylsilyl groups. Some or all of the ring carbon atoms of the cyclopentadiene ring may be substituted with the aforementioned groups but, preferably, the ring carries 3, 4 or 5 substituents, and these substituents may be the same or different.

Specific examples of preferred compounds in the context of the present invention include the 1,4-di(triisopropylsilyl)cyclooctatetraene/pentamethylcyclopentadienyl mixed sandwich uranium(III) complex (IV), the 1,4-di(triisopropylsilyl)cyclooctatetraene/tetramethylcyclopentadienyl mixed sandwich uranium(III) complex (V), and the 1,4-di(triisopropylsilyl)cyclooctatetraene/hexamethylindenyl mixed sandwich uranium(III) complex (VI).

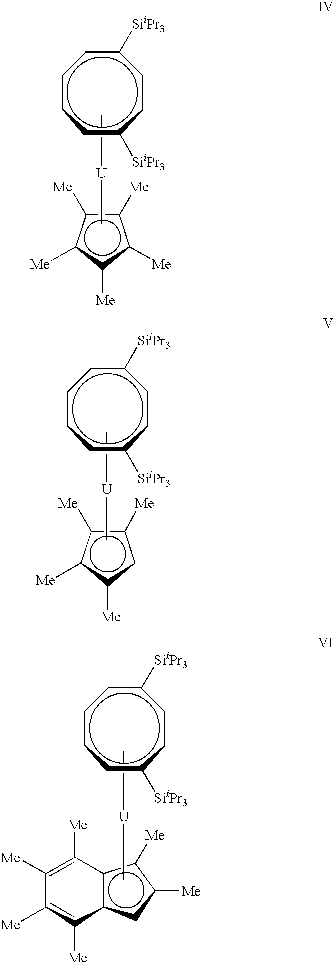

The complexes which are so obtained are found to react with carbon monoxide at atmospheric pressure at temperatures anywhere between −78° and 25° C. in an inert solvent such as diethyl ether or toluene to form squarate or deltate derivatives. Similar results have been successfully achieved by the reaction of the complexes with carbon dioxide, whilst the complexes may also activate nitrogen monoxide, ammonia, sulphur dioxide and carbon disulphide.

The method according to the first aspect of the present invention provides an efficient and convenient means for the removal of gases such as the oxides of carbon, nitrogen and sulphur from the atmosphere through their reaction with the metal complexes, including those according to the second aspect of the invention. Accordingly, the method according to the first aspect of the invention is particularly useful in the removal of so-called greenhouse gases from the atmosphere, and is therefore of potentially very great value environmentally.

1. A method for binding gaseous molecules, said method comprising contacting gases comprising said gaseous molecules with at least one trivalent metal complex, said trivalent metal complex comprising a sandwich complex of an actinide metal or a transition metal, wherein said gases comprise polar gaseous molecules of greenhouse gases, said greenhouse gases comprising at least one of carbon dioxide, nitrogen monoxide, nitrogen dioxide, dinitrogen monoxide, sulphur dioxide, ammonia, hydrogen sulphide, carbon disulphide, hydrogen and hydrocarbon gases, wherein said binding comprises the reductive combination of said gaseous molecules.

2. The method as of claim 1 wherein said method is carried out at ambient temperature and pressure.

3. The method as of claim 1 wherein said actinide metal comprises uranium.

4. The method of claim 1 wherein said transition metal comprises titanium, zirconium or hafnium.

5. The method of claim 1 wherein said sandwich complex comprises a sandwich complex of uranium which comprises two aromatic ring systems.

6. The method of claim 5 wherein said aromatic ring systems are selected from the group consisting of C₅ to C₁₀ aromatic rings.

7. The method of claim 6 wherein said aromatic ring systems are selected from the group consisting of C₅ to C₈ aromatic rings.

8. The method of claim 6 wherein said aromatic ring systems are selected from the group consisting of pentalenyl, indenyl, cyclopentadienyl and cyclooctatetraene rings.

9. The method of claim 7 wherein said aromatic ring systems are selected from the group consisting of cyclopentadienyl and cyclooctatetraene rings.

10. The method of claim 9 wherein said trivalent metal complex comprises a 1,4-di(triisopropylsilyl)cyclooctatetraene/methylated cyclopentadienyl mixed sandwich uranium(III) complex.

11. The method of claim 10 wherein said trivalent metal complex comprises a 1,4-di(triisopropylsilyl)cyclooctatetraene/pentamethyl-, tetramethyl- or trimethylcyclopentadienyl mixed sandwich uranium(III) complex.

12. The method of claim 1 wherein said gaseous molecules comprise carbon dioxide and said reductive combination produces higher oxygenated hydrocarbons.

13. A trivalent metal sandwich complex of uranium which comprises a 1,4-di(triisopropylsilyl)cyclooctatetraene/methylated indenyl mixed sandwich uranium(III) complex.

14. The trivalent metal complex of claim 13 wherein said 1,4-di(triisopropylsilyl)cyclooctatetraene/methylated indenyl mixed sandwich uranium(III) complex comprises a 1,4-di(triisopropylsilyl)cyclooctatetraene/hexamethylindenyl mixed sandwich uranium(III) complex.

15. A method for the removal of greenhouse gases from the atmosphere comprising the method of claim 1.
